(19) United States
(12) Patent Application Publication
(10) Pub. No.: US 2009/0193607 A1
(43) Pub. Date: Aug. 6, 2009

(54) Method and apparatus for disinfecting handles and hand rails

(76) Inventors: Loren S. Adell, Frisco, TX (US); Michael L. Adell, Frisco, TX (US)

Correspondence Address: W. THOMAS TIMMONS, 1320 PRUDENTIAL DRIVE, SUITE 208, DALLAS, TX, 75235-4117, US

(21) Appl. No.: 12/012,912

(22) Filed: Feb. 6, 2008

(51) Int. Cl. B08B 1/00

(52) U.S. Cl. 15/246

(57) ABSTRACT

An apparatus is disclosed for disinfecting or sanitizing a handle or a handrail. A sanitizer substantially surrounds a portion of a handle or handrail that would come into contact with a user of the handle or handrail, and the sanitizer and handle or handrail are moved with respect to each other so that the sanitizer sanitizes substantially the entire portion of the handle or handrail that would come into contact with a user of the handle or handrail. In one arrangement, an absorbent applicator substantially surrounds a longitudinal portion of the handle or handrail, a disinfectant is in the absorbent applicator, and a gripper holds the absorbent applicator in contact with the handle or handrail. The gripper is capable of sliding longitudinally with respect to the handle or handrail, thereby distributing the disinfectant onto the handle or handrail. In an arrangement for a movable handrail, the gripper is stationary and the movable handrail moves through the stationary gripper, thereby disinfecting the movable handrail. In another arrangement, the sanitizer includes a fluid chamber and a disinfectant in the fluid chamber. The portion of the handle or handrail which would come into contact with a user of the handle or handrail passes through the disinfectant. A wiper wipes the excess disinfectant from the handle or handrail. In one embodiment, the wiper comprises a brush or a sponge or sponge-like material. In other arrangements, the sanitizer includes an ultraviolet light or a heated sanitizer chamber or through which the handle or handrail passes.

### CROSS-REFERENCE TO RELATED APPLICATIONS

### Statement Regarding Federally Sponsored Research or Development

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to disinfecting handles and handrails.

2. Description of Related Art

Some supermarkets and other companies which use shopping carts provide customers with disposable sanitary wipes for wiping the handles of the shopping carts. Others have attempted to have removable handle covers so that a shopper removes the old cover, revealing a new cover.

### BRIEF SUMMARY OF THE INVENTION

An apparatus according to the present invention for disinfecting or sanitizing a handle or a handrail includes a sanitizer which substantially surrounds a portion of a handle or handrail that would come into contact with a user of the handle or handrail, and a means for moving the sanitizer and handle or handrail with respect to each other so that the sanitizer sanitizes substantially the entire portion of the handle or handrail that would come into contact with a user of the handle or handrail.

One embodiment of the present invention an absorbent applicator which substantially surrounds a longitudinal portion of the handle or handrail and is in contact therewith, a disinfectant in the absorbent applicator, and a gripper for holding the absorbent applicator in contact with the handle or handrail. The gripper is capable of sliding longitudinally with respect to the handle or handrail so that sliding the gripper with respect to the handle or handrail distributes the disinfectant onto the handle or handrail.

In one embodiment of the apparatus for a cart handle, a user manually slides the gripper back and forth along the handle, thereby disinfecting the handle. In a preferred form, the gripper includes a snap fit so that the gripper can be removed from the cart handle. This allows an old absorbent applicator to be replaced by a new absorbent applicator. One suitable absorbent applicator is made of a sponge or sponge-like material.

In another form of the apparatus, a user either holds the gripper onto the handle or clips the gripper onto the handle. The user manually slides the gripper back and forth along the handle, thereby disinfecting the handle. This form of the apparatus is especially well suited for automotive steering wheel handles.

In another embodiment of the apparatus for a movable handrail, the gripper is stationary and the movable handrail moves through the stationary gripper, thereby disinfecting the movable handrail. In a preferred form of this embodiment, the gripper includes upper and lower holders for upper and lower applicators. The gripper can be similar to the gripper of the prior embodiment, which can be a snap fit so that the gripper can be removed from the movable handrail, and an old absorbent applicator can be replaced by a new absorbent applicator. Similarly, one suitable absorbent applicator is made of a sponge or sponge-like material.

In another embodiment of an apparatus according to the present invention, the sanitizer includes a fluid chamber and a disinfectant in the fluid chamber. A handle or handrail passes through the fluid chamber and the portion of the handle or handrail which would come into contact with a user of the handle or handrail passes through the disinfectant. A wiper wipes the excess disinfectant from the handle or handrail. In one embodiment, the wiper comprises a brush or a sponge or sponge-like material.

In another embodiment of an apparatus according to the present invention, the sanitizer includes an ultraviolet light through which the handle or handrail passes.

In yet another embodiment of an apparatus according to the present invention, the sanitizer comprises a heated sanitizer chamber through which the handle or handrail passes.

These and other objects, advantages and features of this invention will be apparent from the following description taken with reference to the accompanying drawing, wherein is shown a preferred embodiment of the invention.

### BRIEF DESCRIPTION OF THE SEVERAL VIEWS OF THE DRAWING

FIG. 1 is a perspective view of a shopping cart incorporating an apparatus for disinfecting the handle according to the present invention;

FIG. 2 is a detail view of the handle and apparatus for disinfecting the handle of FIG. 1;

FIG. 3 is the handle and the apparatus for disinfecting the handle of FIG. 1 and FIG. 2;

FIG. 4 is a longitudinal cross section of the handle and the apparatus for disinfecting the handle of FIG. 1, FIG. 2 and FIG. 3;

FIG. 5 is a cross transverse cross section of the handle and the apparatus for disinfecting the handle of FIG. 1;

FIG. 6 is a pictorial representation of a bag containing a refill of an applicator according to the present invention;

FIG. 7 is a pictorial representation of an escalator having a handrail and an apparatus for disinfecting a handrail according to the present invention;

FIG. 8 is a lateral cross-section of an escalator hand rail in the return position;

FIG. 9 is a symbolic representation of alternative embodiments of the present invention;

FIG. 10 is one embodiment of the present invention of FIG. 9;

FIG. 11 is another embodiment of the present invention of FIG. 9;

FIG. 12 is yet another embodiment of the present invention of FIG. 9;

FIG. 13 is a portable embodiment of the present invention as used on an automotive steering wheel; and

FIG. 14 is a sectional view of the invention of FIG. 13 taken along lines 14-14.

### DETAILED DESCRIPTION OF THE INVENTION

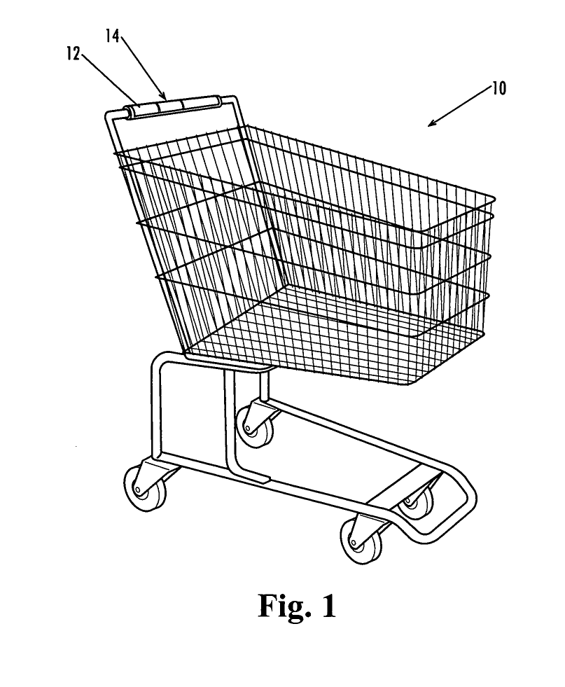

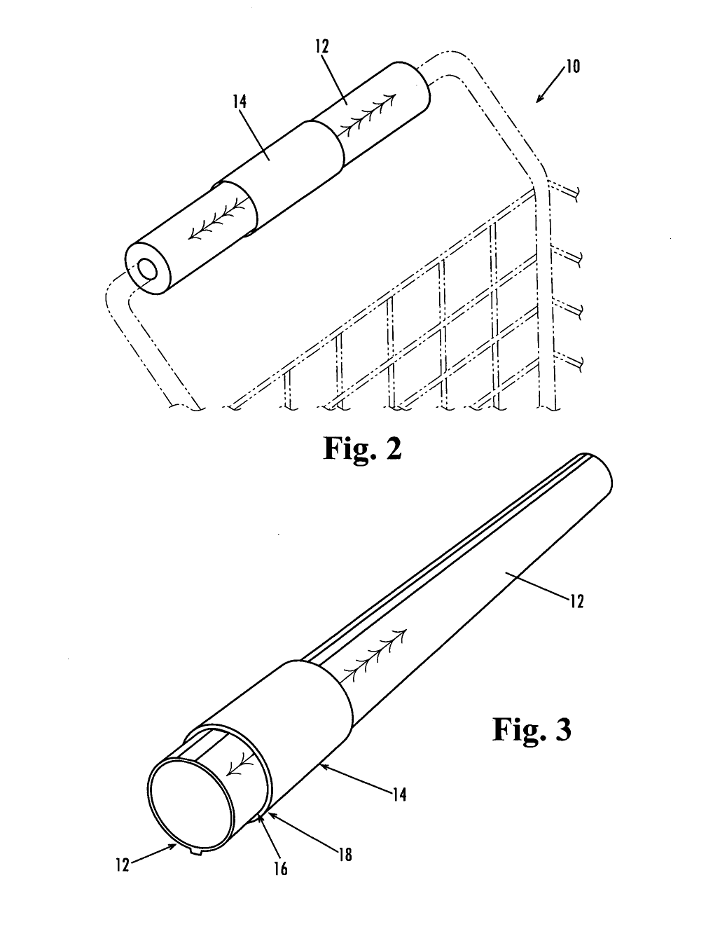

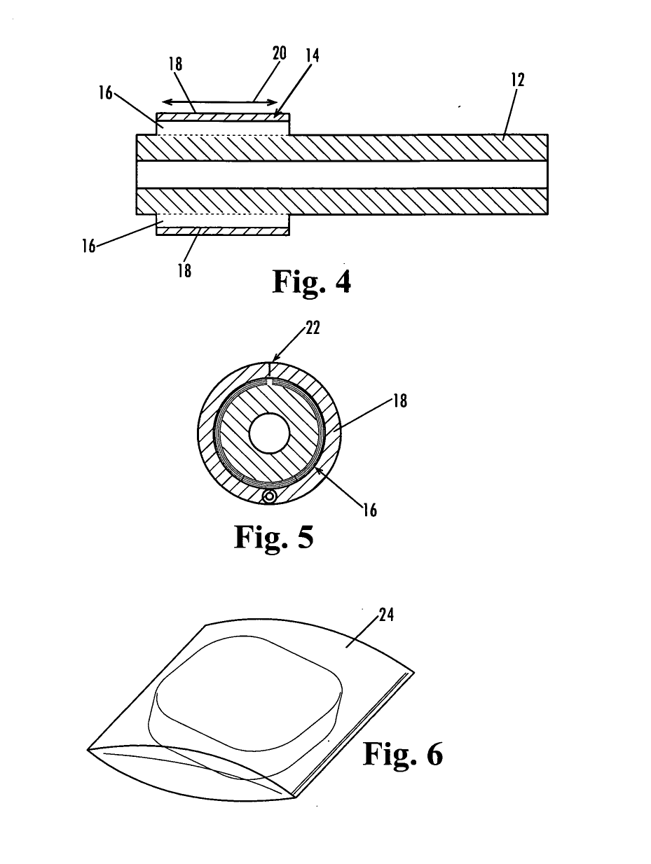

Referring now to the drawing, and in particular to FIG. 1, FIG. 2, FIG. 3 and FIG. 4, a shopping cart incorporating an apparatus according to the present invention is referred to generally by reference numeral 10. Shopping cart 10 includes a handle 12 and an apparatus 14 for disinfecting handle 12. Apparatus 14 for disinfecting a handle or a handrail includes an absorbent applicator 16 which substantially surrounds a longitudinal portion of the handle 12 or a handrail and is in contact therewith, a disinfectant in the absorbent applicator, and a gripper 18, preferably comprising a hard plastic shell, for holding the absorbent applicator in contact with the handle or handrail. Gripper 18 is capable of sliding longitudinally with respect to the handle or handrail so that sliding the gripper with respect to the handle or handrail distributes the disinfectant onto the handle or handrail.

In one embodiment of the apparatus for cart handle 12, a user manually slides the gripper back and forth 20 along the handle, thereby disinfecting the handle. Referring specifically to FIG. 5, in a preferred form, gripper 14 includes a snap fit 22 so that the gripper can be removed from cart handle 12. Referring also to FIG. 6, this allows an old absorbent applicator to be replaced by a new absorbent applicator from package 24. One suitable absorbent applicator is made of a sponge or sponge-like material.

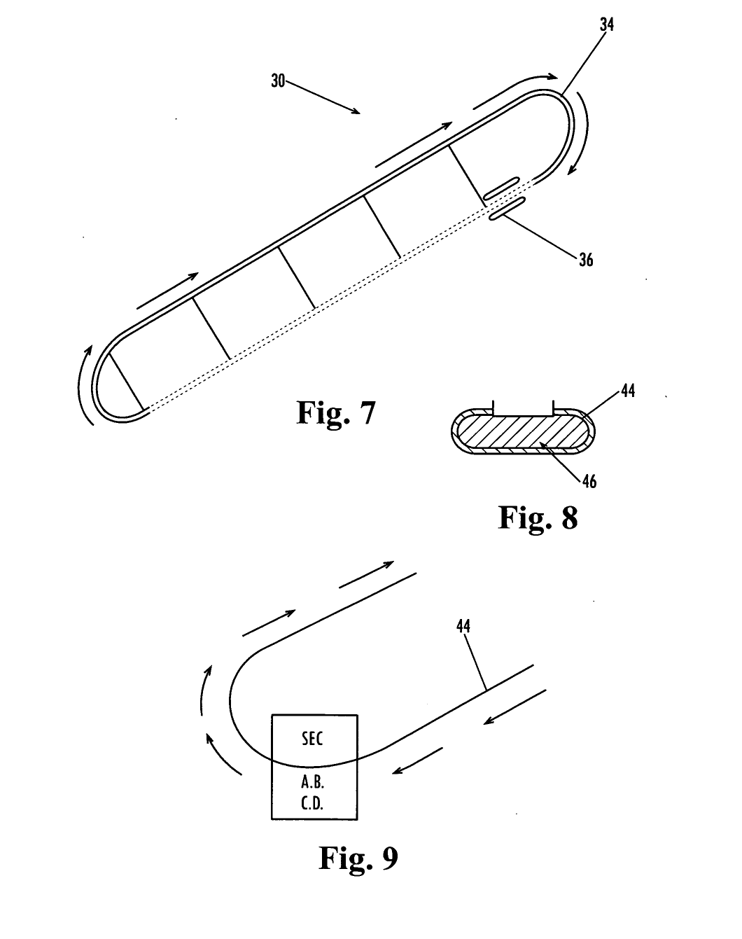

Referring now to FIG. 7, an escalator incorporating another embodiment of the apparatus is referred to generally by reference numeral 30. Escalator 30 includes an apparatus 32 for disinfecting a movable-handrail 34. Gripper 36 is stationary and the movable handrail moves through the stationary gripper, thereby disinfecting the movable handrail. In a preferred form of this embodiment, Gripper 36 comprises upper and lower holders 38 and 40 for upper and lower applicators 42 and 44. A different form of the gripper can comprise a snap fit similar to that shown in the prior embodiment so that the gripper can be removed from the movable handrail, and an old absorbent applicator can be replaced by a new absorbent applicator. Similarly, one suitable absorbent applicator is made of a sponge or sponge-like material.

Referring now to FIG. 8, FIG. 9 and FIG. 10, another embodiment of an apparatus according to the present invention is referred to generally by reference numeral 40. The sanitizer includes a fluid chamber 42 and a disinfectant (not shown) in the fluid chamber. A handle or handrail 44 passes through fluid chamber 42 and the portion 46 of the handle or handrail which would come into contact with a user of the handle or handrail passes through the disinfectant. The disinfectant can be soaked onto the handrail or brushed or rolled onto it. A wiper 48 wipes the excess disinfectant from the handle or handrail. In one embodiment, the wiper comprises a brush or a sponge or sponge-like material.

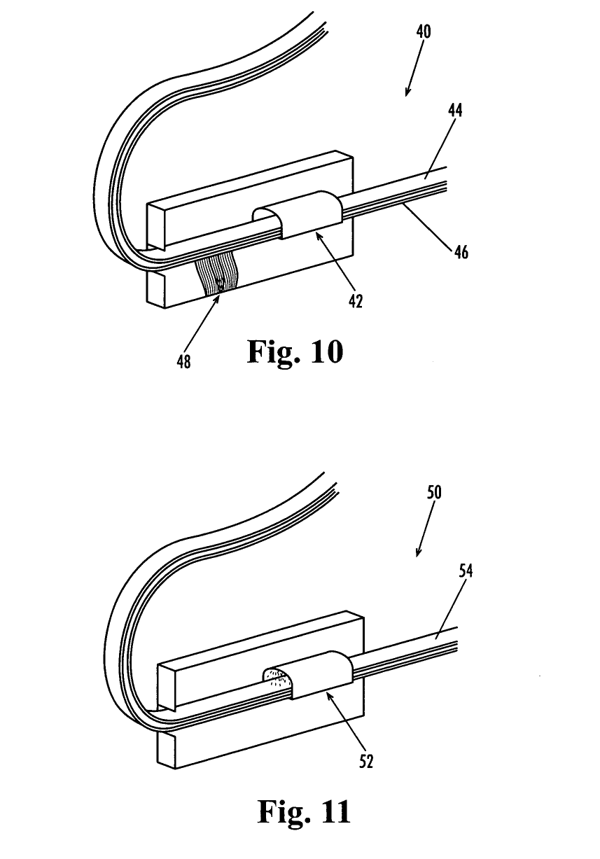

Referring now to FIG. 11, another embodiment of an apparatus according to the present invention is referred to generally by reference numeral 50. In apparatus 50, the sanitizer includes an ultraviolet light 52 through which a handle or handrail 54 passes.

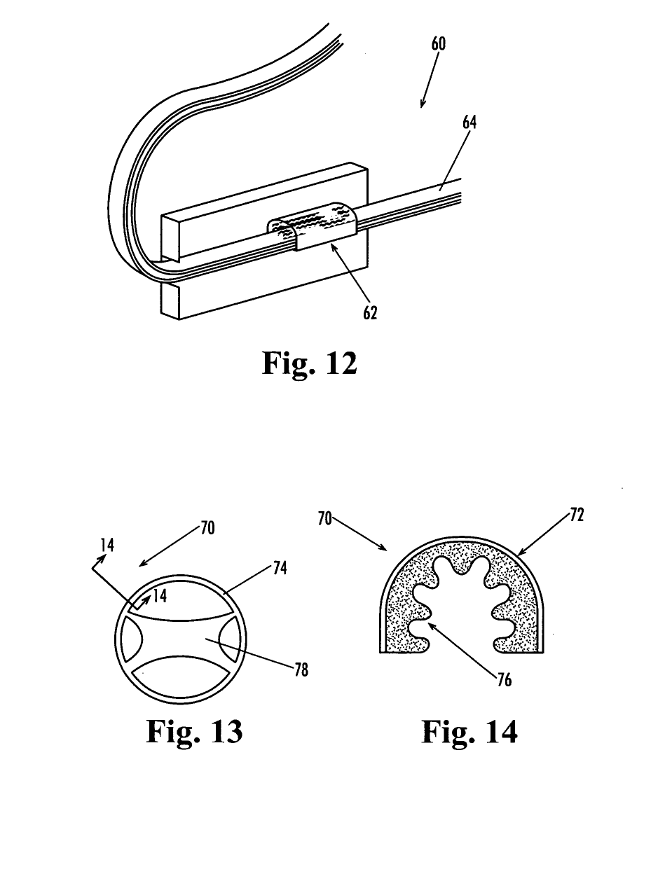

Referring to FIG. 12, yet another embodiment of an apparatus according to the present invention is referred to by reference numeral 60, the sanitizer comprises a heated sanitizer chamber 62 through which a handle or handrail 64 passes.

Referring now to FIG. 13 and FIG. 14, a portable form of the apparatus is referred to by reference numeral 70. A user either holds a gripper 72 onto a handle 74 or clips gripper 72 onto the handle. Gripper 72 holds an inner absorbent material, such as a sponge 76, which contains the cleaner or disinfectant. The user manually slides the gripper back and forth along the handle, thereby disinfecting the handle. This portable form of the apparatus can be used for shopping carts or any other handle or railing, but it is especially well suited for use on an automotive steering wheel 78.

From the foregoing, it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. An apparatus for disinfecting or sanitizing a handle or a handrail, comprising in combination:
a sanitizer which substantially surrounds a portion of a handle or handrail that would come into contact with a user of the handle or handrail; and
a means for moving the sanitizer and handle or handrail with respect to each other so that the sanitizer sanitizes substantially the entire portion of the handle or handrail that would come into contact with a user of the handle or handrail.

2. An apparatus according to claim 1, wherein the sanitizer comprises in combination:
an absorbent applicator which substantially surrounds the longitudinal portion of the handle or handrail that would come into contact with a user of the handle or handrail and is in contact therewith:
a disinfectant in the absorbent applicator; and
the means for moving the sanitizer and handle or handrail with respect to each other comprises a gripper for holding the absorbent applicator in contact with the handle or handrail, wherein the gripper is capable of sliding longitudinally with respect to the handle or handrail so that sliding the gripper with respect to the handle or handrail distributes the disinfectant onto the handle or handrail.

3. An apparatus according to claim 2, for a cart handle, wherein a user manually slides the gripper back and forth along the handle, thereby disinfecting the handle.

4. An apparatus according to claim 3, wherein the gripper comprises a snap fit so that the gripper can be removed from the cart handle, and an old absorbent applicator can be replaced by a new absorbent applicator.

5. An apparatus according to claim 3, wherein the absorbent applicator comprises a sponge or sponge-like material.

6. An apparatus according to claim 5, wherein the gripper comprises a snap fit so that it can be removed from the cart handle, and an old absorbent applicator can be replaced by a new absorbent applicator.

7. An apparatus according to claim 2, for a movable handrail, wherein the gripper is stationary and the movable handrail moves through the stationary gripper, thereby disinfecting the movable handrail.

8. An apparatus according to claim 7, wherein the gripper comprises a snap fit so that the gripper can be removed from the movable handrail, and an old absorbent applicator can be replaced by a new absorbent applicator.

9. An apparatus according to claim 7, wherein the absorbent applicator comprises a sponge or sponge-like material.

10. An apparatus according to claim 9, wherein the gripper comprises a snap fit so that the gripper can be removed from the movable handrail, and an old absorbent applicator can be replaced by a new absorbent applicator.

11. An apparatus according to claim 9, wherein the gripper comprises upper and lower holders for upper and lower applicators.

12. An apparatus according to claim 7, wherein the gripper comprises upper and lower holders for upper and lower applicators.

13. An apparatus according to claim 1, wherein the sanitizer comprises in combination:
a fluid chamber;
a disinfectant in the fluid chamber, wherein a handle or handrail passes through the fluid chamber and the portion of the handle or handrail which would come into contact with a user of the handle or handrail passes through the disinfectant; and
a wiper which wipes the excess disinfectant from the handle or handrail.

14. An apparatus according to claim 13, wherein the wiper comprises a brush or a sponge or sponge-like material.

15. An apparatus according to claim 1, wherein the sanitizer comprises an ultraviolet light through which the handle or handrail passes.

16. An apparatus according to claim 1, wherein the sanitizer comprises a heated sanitizer chamber through which the handle or handrail passes.

17. An apparatus according to claim 2, wherein a user holds the gripper onto the handle and manually slides the gripper back and forth along the handle, thereby disinfecting the handle.

18. An apparatus according to claim 2, wherein a user clips the gripper onto the handle and manually slides the gripper back and forth along the handle, thereby disinfecting the handle.

19. An apparatus according to claim 2, for an automotive steering wheel handle, wherein a user holds the gripper onto the steering wheel handle and manually slides the gripper back and forth along the handle, thereby disinfecting the handle.

20. An apparatus according to claim 2, for an automotive steering wheel handle, wherein a user clips the gripper onto the steering wheel handle and manually slides the gripper back and forth along the handle, thereby disinfecting the handle.
